(19) United States
(12) Patent Application Publication
(10) Pub. No.: US 2012/0019193 A1
(43) Pub. Date: Jan. 26, 2012

(54) CHARGING AND POWER SUPPLYING METHOD FOR TERMAL, AND TERMINAL

(75) Inventors: Haifeng Yu, Beijing (CN); Hao Chen, Beijing (CN)

(73) Assignees: Beijing Lenovo Software Ltd., Beijing (CN); Lenovo (Beijing) Limited, Beijing (CN)

(21) Appl. No.: 13/259,985

(22) PCT Filed: Sep. 14, 2010
(86) PCT No.: PCT/CN2010/001411

§ 371 Date: Sep. 23, 2011

(30) Foreign Application Priority Data
Sep. 21, 2009 (CN) 200910093444.3

(51) Int. Cl. H02J 7/00

(52) U.S. Cl. 320/103; 320/107

(57) ABSTRACT

Embodiments of the present invention relate to a charging method for a terminal, a power supplying method for a terminal, and a terminal. The terminal comprises at least a master device supply. The method comprises: detecting a power level of a battery of a second terminal when the second terminal is in connection with the terminal, and when the power level of the battery of the second terminal is less than a predetermined first charge threshold, controlling the master device supply to be connected with the battery of the second terminal, such that the master device supply charges the battery of the second terminal. According to the embodiments of the present invention, it is possible to ensure that the battery of the second terminal can carry as much power as possible. in case that the power of the battery of the terminal is low, the battery of the second terminal can supply power to the terminal and the second terminal to maintain the operation of them. As a result, the usage, stability, and convenience of the terminal can be improved.

### TECHNICAL FIELD

The invention relates to the field of terminal technology, and particularly to a charging method for a terminal, a power supplying method for a terminal, and a terminal.

### BACKGROUND

The development of the terminal technology has enabled interconnection and data exchange between two portable devices. For example, a notebook computer can be connected to and exchange data with a mobile phone. Meanwhile, the notebook computer can unidirectionally charge the mobile phone connected thereto. That is, when two portable devices are interconnected, one acts as a master device, and the other acts as a slave device, The master device and the slave device each have an independent battery supply subsystem. When the master device and the slave device operate separately, the respective battery supply subsystems of the master device and the slave device respectively supply power to the master device and the slave device independently. And when the master device and the slave device are interconnected, the master device can supply power to the slave device, and further the data exchange is enabled.

In studying and practicing the prior art technology, the inventor found that in the prior art, after the master device and the slave device are interconnected, only unidirectional charging from the master device to the slave device is possible, but the slave device cannot supply power to the master device. For example, the notebook computer can charge the mobile phone, but the mobile phone cannot supply power to the notebook computer Therefore, when the battery of the notebook computer (master device) is in a state of low power, the power in the battery of the mobile phone cannot be used to meet an urgent need. This degrades the usage of the portable devices and the users' experiences.

### SUMMARY OF THE INVENTION

According to aspects of the present invention, there are provided a charging method for a terminal, a power supplying method for a terminal, and a terminal, to improve the usage, stability, and convenience of the terminal.

In order to solve the above problems, according to an aspect of the present invention, there is provided a charging method for a terminal comprising at least a master device supply, comprising:
detecting a power level of a battery of a second terminal when the second terminal is in connection with the terminal, and
when the power level of the battery of the second terminal is less than a predetermined first charge threshold, controlling the master device supply to be connected with the battery of the second terminal, such that the master device supply charges the battery of the second terminal.

According to a further aspect of the present invention, there is also provided a power supplying method for a terminal, comprising:
detecting a connection state of a battery of the terminal when a second terminal is in connection with the terminal;
when the connection of the battery of the terminal is normal, the terminal controlling the battery of the terminal to supply power to the terminal and the second terminal; and
when the power level of the battery of the terminal is less than a predetermined first discharge threshold, the terminal controlling a battery of the second terminal to supply power to the terminal and the second terminal.

According to a further aspect of the present invention, there is provided a terminal comprising at least a master device supply, comprising:
a detecting unit configured for detecting a power level of a battery of a second terminal when the second terminal is in connection with the terminal; and
a control unit configured for controlling the master device supply to be connected with the battery of the second terminal when the power level of the battery of the second terminal is less than a predetermined first charge threshold, such that the master device supply charges the battery of the second terminal.

According to a further aspect of the invention, there is further provided a terminal, comprising:
a detecting unit configured for detecting a connection state of a battery of the terminal when a second terminal is in connection with the terminal; and
a control unit configured for controlling the battery of the terminal to supply power to the terminal and the second terminal when the second terminal is in connection with the terminal; and to control the battery of the second terminal to supply power to the terminal and the second terminal when the power level of the battery of the terminal is less than a predetermined first discharge threshold.

According to the embodiments of the present invention, there is provided a strategy for solving problems related with charging and discharging between the two battery supply subsystems of the terminal and the second terminal, to ensure that the battery of the second terminal can carry as much power as possible. In case that the battery of the terminal is in the low power state, the battery of the second terminal can supply power to the terminal and the second terminal to maintain the operation of them As a result, the usage, stability, and convenience of the terminal can be improved.

### BRIEF DESCRIPTION OF THE DRAWINGS

FIG. 1 is a flow chart showing a charging method for a terminal according to an embodiment of the present invention;

FIG. 2 is a flow chart showing an instance of the charging method for a terminal according to an embodiment of the present invention;

FIG. 3 is a flow chart showing a discharging method for a terminal according to an embodiment of the present invention;

FIG. 4 is a flow chart showing an instance of the discharging method for a terminal according to an embodiment of the present invention;

FIG. 5 is a structural diagram showing a first configuration of a terminal according to an embodiment of the present invention;

FIG. 6 is a structural diagram showing a master device and a slave device in a connection state according to an embodiment of the present invention;

FIG. 7 is a structural diagram showing a connector for connecting a master device and a slave device according to an embodiment of the present invention;

FIG. 8 is a structural diagram showing a further connector for connecting a master device and a slave device according to an embodiment of the present invention,

FIG. 9 is a structural diagram showing a second configuration of a terminal according to an embodiment of the present invention; and

FIG. 10 is a structural block diagram showing a terminal and a second terminal in a connection state according to an embodiment of the present invention.

### DETAILED DESCRIPTION OF THE PREFERRED EMBODIMENTS

Embodiments of the present invention will be described in detail with reference to the drawings.

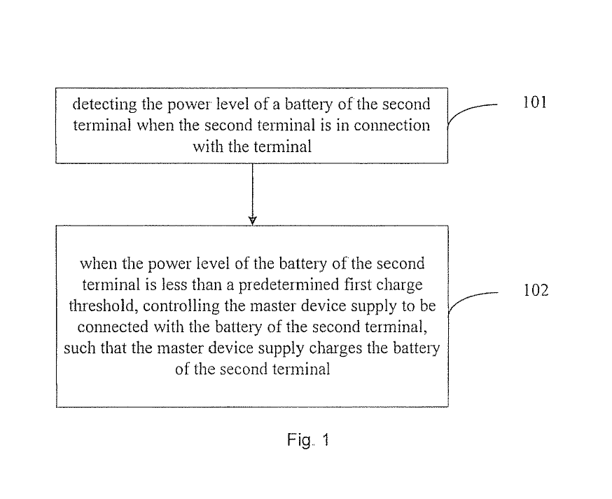

FIG. 1 is a flow chart showing a charging method for a terminal according to an embodiment of the present invention, the terminal comprising at least a master device supply. In this embodiment, the terminal is a master device, and a second terminal is a slave device, The method may comprise:
Step 101: detecting the power level of a battery of the second terminal when the second terminal is in connection with the terminal, and
Step 102: when the power level of the battery of the second terminal is less than a predetermined first charge threshold, controlling the master device supply to be connected with the battery of the second terminal, such that the master device supply charges the battery of the second terminal.

In the step 101, detecting the power level of the battery of the second terminal may comprise:
a microprocessor of the terminal acquiring a power state of the battery of the second terminal via a connector and a system management bus, and
determining whether the power level of the battery of the second terminal is less than the predetermined first charge threshold, and if so, performing step 102.

The master device supply may be a master device supply adapter or a master device battery.

Optionally, if the master device supply is the master device supply adapter, which is connected with an external power supply, the method may further comprise.
when the power level of the battery of the second terminal reaches the predetermined first charge threshold, controlling the master device supply to be connected with the battery of the terminal, such that the master device supply charges the battery of the terminal.

Optionally, the method may further comprise: when the power level of the battery of the terminal reaches a predetermined second charge threshold, controlling the master device supply to resume the charging of the battery of the second terminal; and when the battery of the second terminal is fully charged, controlling the master device supply to resume the charging of the battery of the terminal until it is fully charged.

Optionally, when the power level of the battery of the second terminal reaches the predetermined first charge threshold, the method may further comprise: the microprocessor of the master device determining whether the battery of the terminal needs to be charged; and if the battery of the terminal needs to be charged, performing the step of controlling the master device supply to be connected with the battery of the terminal such that the master device supply charges the battery of the terminal.

Optionally, the terminal may comprise but is not limited to: a notebook computer, a palmtop computer, a mobile internet device, or other portable devices. The second terminal may comprise but is not limited to: a mobile phone, a MP4, or other portable devices.

In this embodiment, when the master device is connected to a charger in order to be charged, if the microprocessor of the master device determines that the battery of the slave device needs to be charged, it controls a battery charging chip and a supply switching chip of the master device to charge the battery of the slave device. The microprocessor of the master device can acquire the state information regarding battery charging of the slave device via the connector and the system management bus; and the microprocessor of the master device determines whether the battery of the slave device needs to be charged according to the state information of the battery charging of the slave device. For example, when the microprocessor of the master device determines that the power level of the battery of the slave device is less than the predetermined first charge threshold, it controls the battery charging chip and the supply switching chip of the master device to charge the battery of the slave device.

When the microprocessor of the master device determines that the power level of the battery of the slave device reaches the predetermined first charge threshold, it controls the battery charging chip and the supply switching chip of the master device to charge the battery of the master device.

When the microprocessor of the master device determines that the power level of the battery of the master device reaches the predetermined second charge threshold, it controls the battery charging chip and the supply switching chip of the master device to resume the charging of the battery of the slave device, and after the battery of the slave device is fully charged, resume the charging of the battery of the master device until it is fully charged.

In an embodiment of the present invention, the master device and the slave device can be connected via the connector or in other connection ways such as clamping, etc. When the master device is connected to the charger, the master device firstly determines whether the battery of the slave device needs to be charged. If the battery of the slave device needs to be charged, the master device controls the master device supply to be connected with the battery of the slave device, such that the master device supply charges the battery of the slave device. Specifically, the battery charging chip and the supply switching chip of the master device may charge the battery of the slave device. When it is determined that the power level of the battery of the slave device reaches the predetermined first charge threshold, the battery charging chip and the supply switching chip of the master device are controlled to charge the battery of the master device. That is, in case that the master device is connected to the charger, the battery of the slave device is firstly charged, to ensure that the battery of the slave device can carry as much power as possible. After the power level of the battery of the slave device reaches a predetermined charge threshold, the battery of the master device is charged. Further, after the power level of the battery of the master device reaches another predetermined charge threshold (i.e. the predetermined second charge threshold), the battery of the slave device is charged again until it is fully charged, and then the battery of the master device is charged again until it is fully charged. In this way, the battery of the slave device can supply power to the master device in case that the battery of the master device is in the low power state, to maintain the operation of the master device. Thus, the usage, stability, and convenience of the device can be improved.

Of course, since the master device and the slave device each have an independent battery supply subsystem, the battery supply subsystems of the master device and the slave device respectively supply power to the master device and the slave device independently when the master device and the slave device are disconnected. When the master device and the slave device are interconnected (e.g. via the connector, etc.), the two independent battery supply subsystems are associated with each other via e.g. the connector. However, the present invention is not limited thereto.

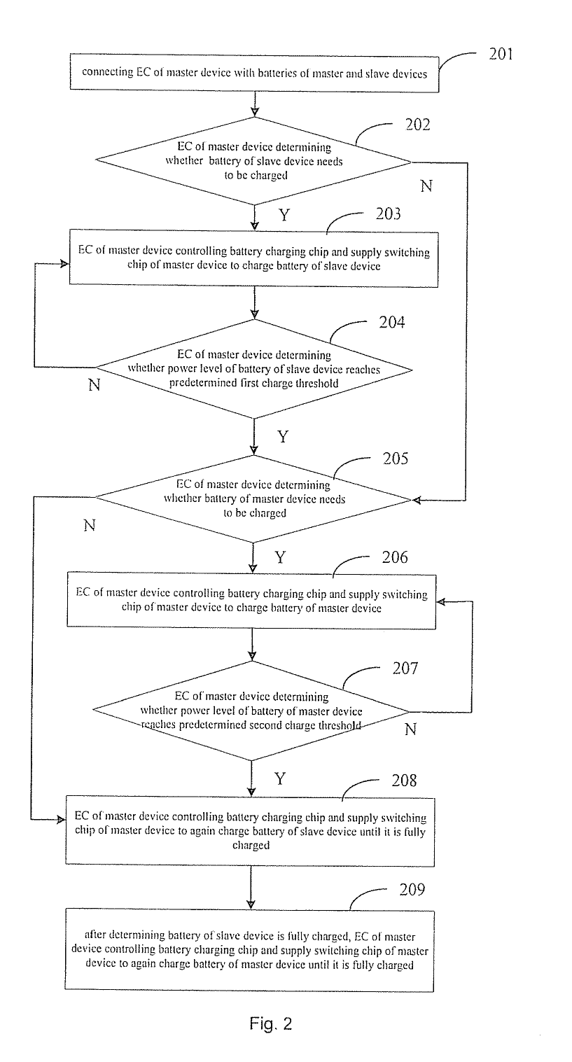

FIG. 2 is a flow chart showing an instance of the charging method for a terminal according to an embodiment of the present invention. In this embodiment, the master device and the slave device are interconnected via a connector. Further, in this embodiment, the master device is a notebook computer for example, and the microprocessor of the master device may be an Embedded Controller (EC) for example. The slave device is a mobile phone for example. However, the present invention is not limited thereto. The method may comprise:
Step 201: connecting the EC of the master device with a battery of the slave device, for example, via the connector, e.g. by connecting a female joint and a male joint;
Step 202: the EC of the master device determining whether the battery of the slave device needs to be charged, and if so, performing step 203; or otherwise, performing step 205;
Step 203: the EC of the master device controlling a battery charging chip and a supply switching chip of the master device to charge the battery of the slave device; particularly, the EC of the master device switching the supply switching chip of the master device to supply power to the battery of the slave device and thus charging the battery of the slave device and controlling parameters such as charging voltage and current associated with the charging of the battery of the slave device;
Step 204: the EC of the master device determining whether the power level of the battery of the slave device reaches a predetermined first charge threshold, and if so, performing step 205, or otherwise, returning to step 203;
Step 205: the EC of the master device determining whether the battery of the master device needs to be charged, and if so, performing step 206; or otherwise, performing step 208;
Step 206: the EC of the master device controlling the battery charging chip and the supply switching chip of the master device to charge the battery of the master device;
Step 207: the EC of the master device determines whether the power level of the battery of the master device reaches a predetermined second charge threshold; and if so, performing step 208; or otherwise, returning to step 206;
Step 208: the EC of the master device controlling the battery charging chip and the supply switching chip of the master device to resume the charging of the battery of the slave device until it is fully charged; and
Step 209: after determining that the battery of the slave device is fully charged, the EC of the master device controlling the battery charging chip and the supply switching chip of the master device to resume the charging of the battery of the master device until it is fully charged.

In the embodiment of the present invention, in case that the master device is connected to a charger, the battery of the slave device is firstly charged, to ensure that the battery of the slave device can carry as much power as possible. In this way, the battery of the slave device can supply power to the master device in case that the battery of the master device is in the low power state, to maintain the operation of the master device, Thus, the usage, stability, and convenience of the device can be improved.

Furthermore, when the microprocessor of the master device determines that the power level of the battery of the master device reaches the predetermined second charge threshold, it controls the battery charging chip and the supply switching chip of the master device to resume the charging of the battery of the slave device, and after the battery of the slave device is fully charged, resume the charging of the battery of the master device until it is fully charged.

For example, most of batteries of the prior art portable devices are lithium ion batteries. A charging process of the lithium ion battery generally comprises two stages of Constant Current (CC) and Constant Voltage (CV). The CC stage is a constant-current procedure, in which the charging current is relatively large and the charging speed is relatively rapid The CV stage is a constant-voltage procedure, in which the charging current gradually decreases and the charging speed is relatively slow. In order to satisfy requirements, the charging operation is performed with respect to the battery of the slave device firstly, and then is switched to charge the battery of the master device when a voltage of the battery of the slave device reaches a peak value which represents a voltage knee point between the CC stage and the CV stage. When a voltage of the battery of the master device reaches a peak value which represents a voltage knee point between the CC stage and the CV stage, the charging operation is again switched to charge the battery of the slave device in the CV stage until it is fully charged. Then the charging operation is switched again to charge the battery of the master device in the CV stage until it is fully charged.

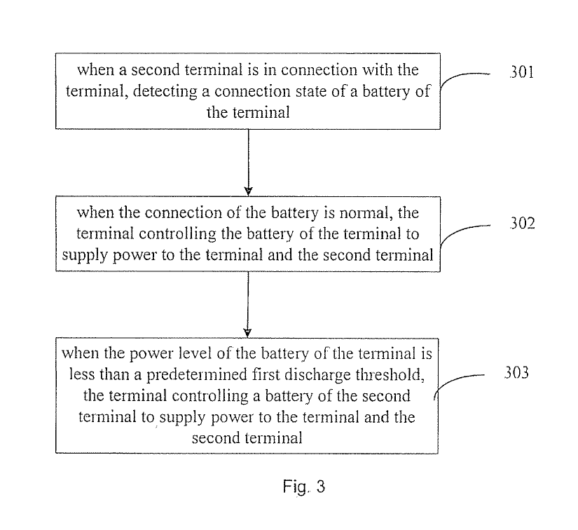

FIG. 3 is a flow chart showing a power supplying method for a terminal according to an embodiment of the present invention. As shown in FIG. 3, the method may comprise:
Step 301: when a second terminal is in connection with the terminal, detecting a connection state of a battery of the terminal;
Step 302: when the connection of the battery is normal, the terminal controlling the battery of the terminal to supply power to the terminal and the second terminal; and
Step 303: when the power level of the battery of the terminal is less than a predetermined first discharge threshold, the terminal controlling a battery of the second terminal to supply power to the terminal and the second terminal.

Optionally, the method may further comprise: when the power level of the battery of the second terminal is less than a predetermined second discharge threshold, initiating a low-power alarm or entering a sleep state.

Optionally, when the power level of the battery of the terminal is less than the predetermined first discharge threshold, the method may further comprise, a microprocessor of the terminal determining whether a battery connection of the second terminal is normal. If the battery connection of the second terminal is normal, the terminal controls the battery of the second terminal to supply power to the terminal and the second terminal; or otherwise, the terminal initiates the low-power alarm or enters the sleep state.

Optionally, the method may further comprise:
the microprocessor of the terminal acquiring the connection state of the battery of the second terminal via a connector and a system management bus; and
determining whether the battery of the second terminal is normally connected according to the connection state.

In this embodiment, when the master device is not connected to a charger, if the microprocessor of the master device determines that the battery connection of the master device is normal, it controls a supply switching chip of the master device to use the battery of the master device to supply power to the master device and to the slave device. That is, when the master device is not connected to the charger and thus is not being charged, after power-on, if the microprocessor of the master device determines that the battery connection of the master device is normal, the microprocessor of the master device controls the supply switching chip of the master device to use the battery of the master device to supply power to the master device and the slave device.

When the power level of the battery of the master device is less than the predetermined first discharge threshold, the microprocessor of the master device controls the supply switching chip of the master device to use the battery of the slave device to supply power to the master device and the slave device. When the microprocessor of the master device determines that the power level of the battery of the slave device is less than the predetermined second discharge threshold, the low-power alarm is initiated

Optionally, the master device may comprise but is not limited to: a notebook computer, a palmtop computer, or a Mobile Internet Device (MID). The slave device may comprise but is not limited to: a mobile phone or an MP4.

In case that the master device is not connected to the charger and thus is not being charged, after power-on, the microprocessor of the master device uses the battery of the master device to supply power to the master device and the slave device firstly. When the power level of the battery of the master device reaches the predetermined first discharge threshold, the battery of the slave device is activated to supply power to the master device and the slave device, until the power level of the battery of the slave device reaches the other predetermined discharge threshold, in which case, the alarm is initiated or the sleep state is activated. Namely, in case that the battery of the master device is the low power state, the microprocessor of the master device can control the battery of the slave device to supply power to the master device and the slave device to maintain the operation of the master device. In this way, the usage, stability, and convenience of the device are improved.

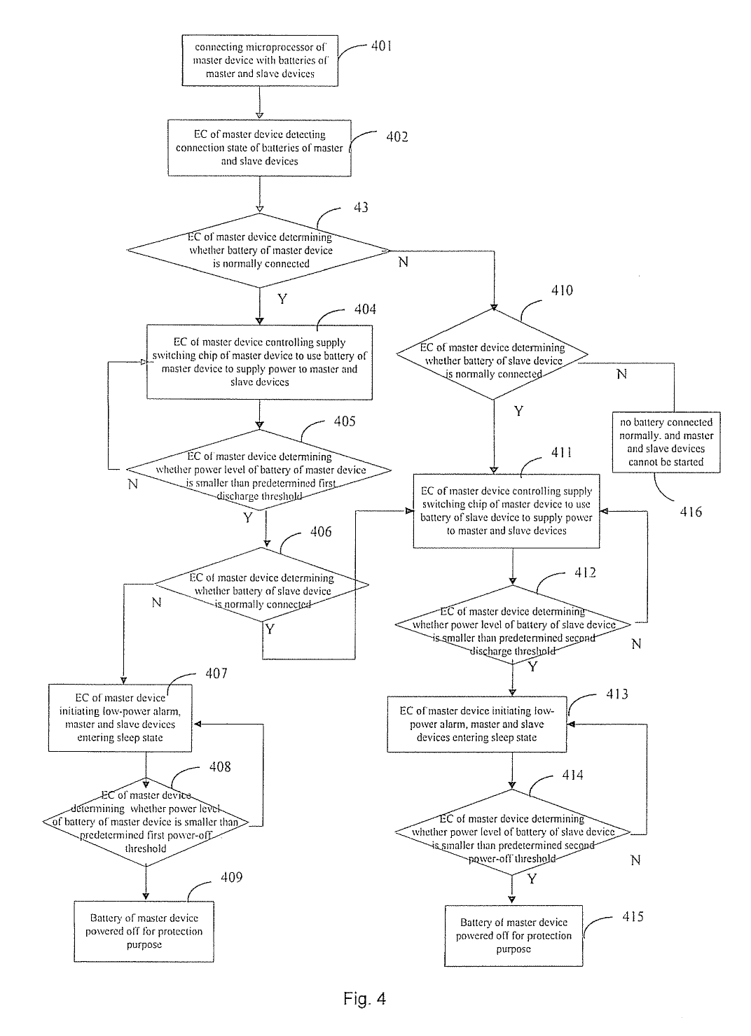

FIG. 4 is a flow chart showing an instance of the power supplying method for a terminal according to an embodiment of the present invention. In this embodiment, the master device is connected with the slave device via a connector. Further, in this embodiment, the master device is a notebook computer for example, and the microprocessor of the master device may be an EC of the notebook computer for example. The slave device is a mobile phone for example. However, the present invention is not limited thereto. The method may comprise:
Step 401: connecting the microprocessor of the master device with a battery of the slave device e.g. via a connector;
Step 402: the EC of the master device detecting the connection state of the battery of the master device and the battery of the slave device e.g. in real time or periodically, wherein the battery of the master device and the battery of the slave device can be detected simultaneously or sequentially, which is not essential to this embodiment;
Step 403: the EC of the master device determining whether the battery of the master device is normally connected, and if so, performing step 404; or otherwise, performing step 410;
Step 404: the EC of the master device controlling the supply switching chip of the master device to use the battery of the master device to supply power to the master device and the slave device. Particularly, the EC of the master device may send control information, which indicates supplying power by the battery of the master device, to the supply switching chip of the master device, and the supply switching chip, upon receiving the information sent from the EC and indicating supplying power by the battery of the master device, switches to supply power to the master device and the slave device using the battery of the master device;
Step 405: the EC of the master device determining whether the power level of the battery of the master device is less than a predetermined first discharge threshold; and if so, performing step 406, or otherwise, returning to step 404;
Step 406: the EC of the master device determining whether the battery of the slave device is normally connected; and if so, performing step 411, or otherwise, performing step 407;
Step 407: the EC of the master device initiating a low-power alarm, and the master device and the slave device entering a sleep state;
Step 408: the EC of the master device determining whether the power level of the battery of the master device is a predetermined first power-off threshold, and if so, performing step 409; or otherwise, returning to step 407;
Step 409: the battery of the master device being powered off for protection purpose and the flow ending;
Step 410: the EC of the master device determining whether the battery of the slave device is normally connected, and if so, performing step 411, or otherwise, performing step 416;
Step 411: the EC of the master device controlling the supply switching chip of the master device to use the battery of the slave device to supply power to the master device and the slave device. Particularly, the EC of the master device may send control information, which indicates supplying power by the battery of the slave device, to the supply switching chip of the master device, and the supply switching chip, upon receiving the information sent from the EC and indicating supplying power by the battery of the slave device, switches to supply power to the master device and the slave device using the battery of the slave device;
Step 412: the EC of the master device determining whether the power level of the battery of the slave device is less than a predetermined second discharge threshold; and if so, performing step 413; or otherwise, returning to step 411;
Step 413: the EC of the master device initiating a low-power alarm, and the master device and the slave device entering a sleep state;
Step 414: the EC of the master device determining whether the power level of the battery of the slave device is a predetermined second power-off threshold, and if so, performing step 415; or otherwise, returning to step 413;
Step 415: the battery of the master device being powered off for protection purpose and the flow ending; and
Step 416: in case that there is no battery normally connected, the master device and the slave device cannot be started.

In case that the master device is not connected to a charger and thus is not being charged, the process is a discharging process. First of all, the master device determines whether the battery of the master device and the battery of the slave device are normally connected, and uses the battery of the master device to supply power to the master device and the slave device firstly. When the power level of the battery of the master device is less than the first discharge threshold, the battery of the slave device is activated to supply power to the master device and the slave device, until the power level of the battery of the slave device is less than the predetermined second discharge threshold.

The battery of the master device is used to supply power to the master device and the slave device. When the battery of the master device reaches the predetermined first discharge threshold, the battery of the slave device is activated to supply power to the master device and the slave device, until the power level of the battery of the slave device reaches the predetermined second discharge threshold, and then the alarm is initiated and then the master device and the slave device enter the sleep state. Namely, in case that the battery of the master device is in the low power state, the master device may control the battery of the slave device to supply power to the master device and the slave device to maintain the operation of the master device. In this way, the usage, stability and convenience of the device are improved. The EC of the master device initiates the alarm in case of low power and the master device and the slave device enter the sleep state After that, if the power level is less than the predetermined power-off threshold, the batteries of the master device and the slave device are shut off for protection purpose.

In this embodiment, the master device firstly uses the battery of the master device to supply power to the master device and the slave device. When the battery of the master device reaches the predetermined discharge threshold, the battery of the slave device is activated to supply power to the master device and the slave device, until the power level of the battery of the slave device reaches the predetermined second discharge threshold, and then the alarm is initiated or the sleep state is activated. Namely, in case that the battery of the master device is in the low power state, the master device may control the battery of the slave device to supply power to the master device and the slave device to maintain the operation of the master device. In this way, the usage, stability and convenience of the device are improved.

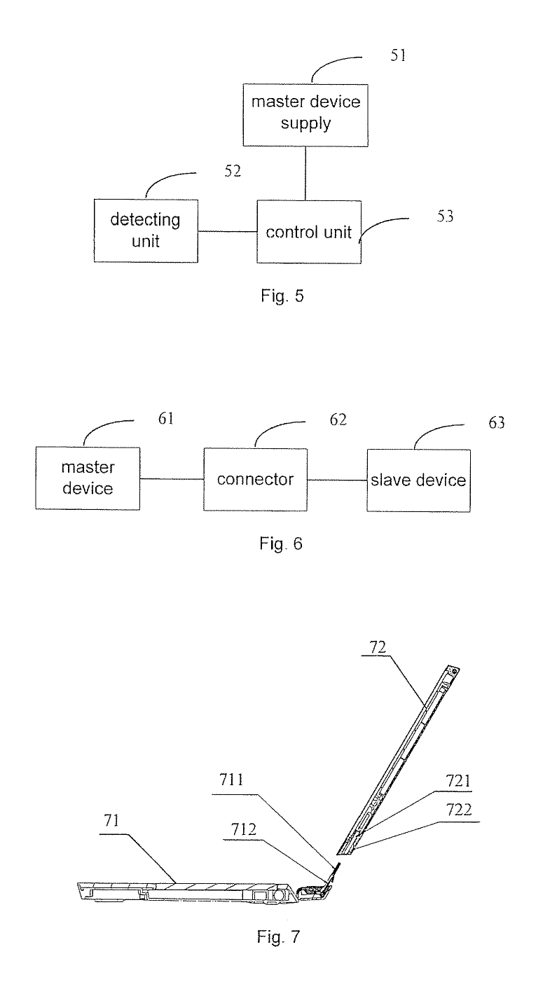

Based on the above methods, according to an embodiment of the present invention, there is also provided a terminal, a schematic diagram showing the configuration of which is shown in FIG. 5. As shown in FIG. 5, the terminal comprises at least a master device supply 51, a detecting unit 52, and a control unit 53. The detecting unit 52 may be configured for detecting the power level of a battery of a second terminal when the second terminal is in connection with the terminal. The control unit 53 may be configured for controlling the master device supply 51 to connect to the battery of the second terminal when the power level of the battery of the second terminal is determined to be less than a predetermined first charge threshold based on the detecting result of the detecting unit 52, such that the master device supply 51 supplies power to the battery of the second terminal.

Optionally, the control unit 53 may further be configured for controlling the master device supply to connect to the battery of the terminal when the power level of the battery of the second terminal reaches the predetermined first charge threshold, such that the master device supply charges the battery of the terminal.

Optionally, the control unit 53 may further be configured for controlling the master device supply to resume the charging of the battery of the second terminal when the power level of the battery of the terminal reaches a predetermined second charge threshold, and to, after the battery of the second terminal is fully charged, control the master device supply to resume the charging of the battery of the terminal until it is fully charged.

The control unit 53 may comprise: a microprocessor, a battery charging chip, and a supply switching chip. The microprocessor may be configured for sending control information, which indicates charging the battery of the second terminal, to the battery charging chip and the supply switching chip of the terminal when the power level of the battery of the second terminal is determined to be less than the predetermined first charge threshold; and to send control information, which indicates charging the battery of the terminal, to the battery charging chip and the supply switching chip of the terminal when the power level of the battery of the second terminal is determined to reach the predetermined first charge threshold.

The supply switching chip may be configured for switching to the battery of the second terminal to charge the battery of the second terminal when it receives the control information sent from the microprocessor and indicating charging the battery of the second terminal, and switch to the battery of the terminal when it receives the control information sent from the microprocessor and indicating charging the battery of the terminal.

The battery charging chip may be configured for controlling the parameters such as charging voltage and current for charging the battery of the terminal or the second terminal when the supply switching chip receives the control information sent from the microprocessor and indicating charging the battery of the terminal or the second terminal.

The detecting unit may particularly comprise: an acquiring unit and a determination unit. The acquiring unit may be configured for acquiring the power state of the battery of the second terminal via a connector and a system management bus. The determination unit may be configured for determining whether the power level of the battery of the second terminal is less than the predetermined first charge threshold, and send the determination result to the control unit.

According to an embodiment of the present invention, a master device and a slave device may be connected in a way shown in FIG. 6. As shown in FIG. 6, the master device 61 and the slave device 62 are connected via a connector 63. The connector 53 may be configured for connecting the master device 61 and the slave device 62, The master device 61 may be configured to, when it is connected to a charger in order to be charged, control a battery charging chip and a supply switching chip of the master device to charge the battery of the slave device if it is determined that the battery of the slave device needs to be charged, and control the battery charging chip and the supply switching chip of the master device to charge the battery of the master device if a microprocessor of the master device determines that the power level of the battery of the slave device reaches a predetermined first charge threshold.

Optionally, the master device may comprise: a microprocessor, a supply switching chip, a battery charging chip, and a battery. The microprocessor may be configured for:, determining whether the battery of the slave device needs to be charged when the master device is connected to a charger in order to be charged, and if so, send a control information, which indicates charging the battery of the slave device, to the battery charging chip and the supply switching chip of the master device, and send a control information, which indicates charging the battery of the master device, to the battery charging chip and the supply switching chip of the master device when the power level of the battery of the slave device is determined to reach the predetermined first charge threshold. The supply switching chip may be configured for: switching to the battery of the slave device to charge the battery of the slave device upon receiving the control information sent from the microprocessor and indicating charging the battery of the slave device, and switch to the battery of the master device to charge the battery of the master device upon receiving the control information sent from the microprocessor and indicating charging the battery of the master device. The battery charging chip may be configured for controlling the parameters such as charging voltage and current for charging the battery of the slave device or the master device when the supply switching chip receives the control information sent from the microprocessor indicating charging the slave device or the master device. The batteries are used for storing power, and supply power to the master device and/or the slave device when the master device is not connected to the charger in order to be charged.

Optionally, the microprocessor may be further configured for determining whether the power level of the battery of the master device reaches a predetermined second charge threshold, and if so, control the battery charging chip and the supply switching chip of the master device to resume the charging of the battery of the slave device; and after the battery of the slave device is fully charged, resume the charging of the battery of the master device until it is fully charged.

Implementations and functions of the respective units of the terminal are similar to those of the above corresponding methods, and detailed descriptions thereof are omitted here.

FIG. 7 is a structural diagram showing a connector for connecting a master device and a slave device according to an embodiment of the present invention. As shown in FIG. 7, the master device 71 and the slave device 72 are connected via the connector. The connector may comprise a first connecting structure and a second connecting structure. In this embodiment, the master device is a host for example, and the slave device is a tablet computer for example. In this case, the connector may comprise: an insertion plate 711 (the second connecting structure) and a fastening hook 712 arranged on a base portion of the master device 71; and an insertion slot 721 (the first connecting structure) and a locking slot 722 arranged on the slave device 72. The insertion plate 711 fits the insertion slot 721, and the fastening hook 712 fits the locking slot 722. There may be two insertion plates, two fastening hooks, two insertion slots, and two locking slots. When the tablet computer as the slave device is connected with the master device 71, it can act as a display unit of both the master device and the slave device.

The connection can be done by the connector in the following way. The slave device 72 is push down such that the insertion plates 711 on the base portion of the master device 71 are inserted into the corresponding insertion slots 721, and thus the slave device 72 is fixed in front, back, left, and right directions. When the insertion plates 711 are inserted to their proper positions, the fastening hooks 712 on the base portion of the master device 71 hook the locking slots 722 of the slave device 72, such that the slave device 72 is fixed in up and down directions.

The base portion may further comprise keys for releasing the fastening hooks from the locking slots, and a pop-up mechanism for pushing the slave device away from the master device by a predetermined distance.

The connector can be disconnected in the following way. When the keys on the left and right side are depressed, the fastening hooks are loosened, and the slave device is released and automatically popped up for e.g. 3 mm. The slave device then can be separated from the master device. There are two keys arranged on both the left and right side for safety, to ensure that the system is separated intentionally, but not accidentally, and thus to prevent the slave device from dropping down and being damaged.

FIG. 8 is a structural diagram showing a further connector for a master device and a slave device according to an embodiment of the present invention. In this embodiment, the master device and the slave device are connected via the connector, Here, the master device is a host for example, and the slave device is a tablet computer for example. As shown in FIG. 8, the tablet computer 1 having display and computation capabilities, the host 2, and a backboard 3 are interconnected respectively via a first connecting structure 4 and a second connecting structure 5. The first connecting structure 4 is arranged on the host 2 for connecting with the backboard 3. The backboard 3 is rotatably arranged on the host 2 via the first connecting structure 4. The first connecting structure 4 can be either an existing pivoting structure such that the backboard 3 may be rotatably fixed on the host 2, or can connect the backboard 3 with the host 2 in a detachable manner. The second connecting structure 5 is arranged on the backboard 3 and the tablet computer 1 for connecting the backboard 3 and the tablet computer 1 The tablet computer 1 is detachably connected with the backboard 3 via the second connecting structure 5. In case that the tablet computer 1 is mounted on the backboard 3 via the second connecting structure 5, the tablet computer 1 may act as a display screen of both the master device and the slave device.

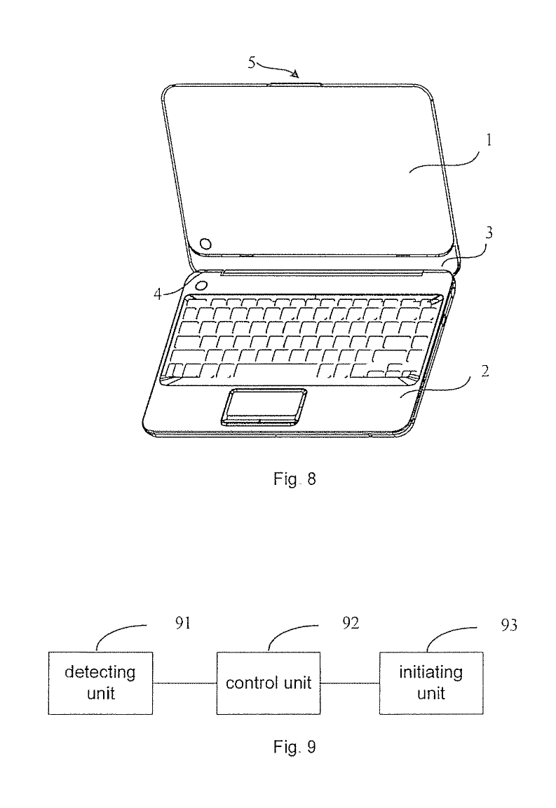

Accordingly, according to an embodiment of the present invention, there is also provided a terminal, a schematic diagram showing the structure of which is shown in FIG. 9. As shown in FIG. 9, the terminal comprises a detecting unit 91 and a control unit 92. The detecting unit 91 may be configured for detecting the connection state of the battery of the terminal when a second terminal is in connection with the terminal. The control unit may be configured for controlling the battery of the terminal to supply power to the terminal and the second terminal when the second terminal is in connection with the terminal; and control the battery of the second terminal to supply power to the terminal and the second terminal when the power level of the battery of the terminal is less than a predetermined first discharge threshold.

Optionally, the terminal may further comprise: an initiating unit 93 for initiating a low-power alarm or initiating a sleep state when the power level of the battery of the second terminal is less than a predetermined second discharge threshold.

The control unit comprises a microprocessor, a supply switching chip, and a rechargeable battery.

The microprocessor may be configured for sending control information, which indicates supplying power by the battery of the terminal, to the supply switching chip of the terminal when the battery of the terminal is normally connected; and send control information, which indicates supplying power by the battery of the second terminal, to the supply switching chip of the terminal when the power level of the battery of the terminal is determined to be less than the predetermined first discharge threshold.

The supply switching chip may be configured for using the battery of the terminal to supply power to the terminal and the second terminal when it receives the control information sent from the microprocessor and indicating supplying power by the battery of the terminal; and switch to the battery of the second terminal and use the battery of the second terminal to supply power to the terminal and the second terminal when it receives the control information sent from the microprocessor and indicating supplying power by the battery of the second terminal.

Implementations and functions of the respective units of the terminal are similar to those of the above corresponding methods, and detailed descriptions thereof are omitted here.

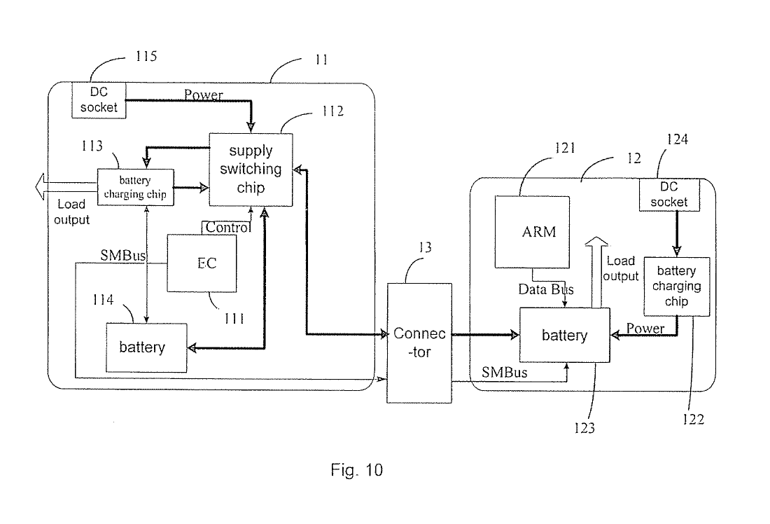

FIG. 10 is a structural diagram showing a master device and a second terminal in a connection state according to an embodiment of the present invention. The master device 11 and the slave device 12 are connected via a connector 13. In this embodiment, the master device 11 is a notebook computer for example, the slave device 12 is a mobile phone for example, and the microprocessor of the master device is an EC for example. As shown in FIG. 10, the device 11 comprises: an EC 111 of the master device, a supply switching chip 112 of the master device, a battery charging chip 113 of the master device, a battery 114 of the master device, and a DC socket 115 of the master device The slave device 112 comprises: an ARM 121 of the slave device, a battery charging chip 122 of the slave device, a battery 123 of the slave device, and a DC socket 124 of the slave device. Specific connections among these components are shown in FIG. 10.

In FIG. 10, as for the master device 11, the line labeled by ‘Power’ is a Power Bus, and the line labeled by ‘SMBus’ is a System Management Bus (SMBus). In this embodiment, the System Management Bus may be an I2C bus or an SPI bus, or other types of data communication bus. The line labeled by ‘Control’ is a general control line The EC 111 as a main control unit controls the switching of the supply switching chip 112 and parameters such as charging voltage and charging current of the battery charging chip 113 according to a predetermined charging and discharging strategy. Meanwhile, the EC 111 acquires battery state information on the battery 114 of the master device 11 and the battery 123 of the slave device 12 via the SMBus, and feeds them back to an upper layer operation system.

As for the slave device 12, the ARM 121 as a main control unit acquires state information of the battery 123 of the slave device via a data communication bus, which may be a double-line SMBus, an I2C bus, or a single-line serial bus, etc. The line labeled by ‘Power’ is a charging line capable of independently charging the slave device, which is used for charging the battery of the slave device in case that the slave device is detached from the master device. The slave device is connected with the master device (the notebook computer) via a physical interface.

In a state where the master device is detached from the slave device, the respective batteries of the master device and the slave device are charged and discharged independently.

As shown in FIG. 10, in a state where the master device is connected with the slave device, the master device may charge the battery of the slave device, and the EC of the master device can acquire all state information of the battery 123 of the slave device. When the master device is not connected to a charger, the battery 114 of the master device is firstly used to supply power to the master device and the slave device. When the power level of the battery 114 of the master device is lower than a predetermined first discharge threshold or there is no battery for the master device, the battery 123 of the slave device may supply power to the master device and the slave device.

In the state where the master device is connected with the slave device, only the charger for the master device can be used to charge the batteries of the master device and the slave device, and the battery 123 of the slave device is firstly charged. When the battery 123 of the slave device is charged to a predetermined first charge threshold, the charging of the battery 114 of the master device is started. When the battery 114 of the master device is charged to a predetermined second charge threshold, the charging of the battery 123 of the slave device is resumed, until it is fully charged. After the battery 123 of the slave device is fully charged, the charging of the battery 114 of the master device is resumed, until it is fully charged. The slave device can be charged in either power-on or power-off state of the master device. The slave device, in either power-on or power-off state, can be charged.

In the state where the master device is connected with the slave device, if the master device is not connected to the charger and thus is not being charged, the following operations are performed. Upon power-on, the battery 114 of the master device is firstly used to supply power to the master device and the slave device When the power level of the battery 114 of the master device is lower than the predetermined first discharge threshold or there is no battery for the master device, the battery 123 of the slave device may supply power to the master device and the slave device. In a state where the master device is powered off, the battery 123 of the slave device does not supply power to the master device, regardless of the remaining power of the battery 114 of the master device.

In the state where the master device is connected with the slave device, the EC collects the state information on the battery 114 of the master device and the battery 123 of the slave device, and the master device displays the state information to the user. When the remaining power of the battery 114 of the master device is lower than the predetermined first discharge threshold, the master device initiates an alarm in the power-on state and then enters into a sleep state. When the remaining power of the battery 123 of the slave device is lower than a predetermined second discharge threshold, the slave device initiates an alarm in the power-on state and then enters into a sleep state When the remaining power of the battery 114 of the master device is lower than a predetermined first power-off threshold, the battery 114 of the master device is powered off for protection purpose. When the remaining power of the battery 123 of the slave device is lower than a predetermined second power-off threshold, the battery 123 of the slave device is powered off for protection purpose.

Therefore, according to embodiments of the present invention, there is provided a strategy for solving problems related with charging and discharging between two battery supply subsystems of the master device and slave device, to ensure that the battery of the slave device may carry as much power as possible, and the battery of the slave device can supply power to the master device in case that the power of the battery of the master device is low to maintain the operation of the master device. In this way, the usage, stability, and convenience of the device are improved.

From the above description of the embodiments, those skilled in the art will understand that the present invention can be implemented by software in combination with necessary general hardware platform. The present invention can also be implemented by hardware, but in many cases the former is better. The essential part or the part making a contribution over the prior art of present invention can be embodied in a software product, which can be stored in storage mediums, such as ROM/RAM, magnetic disk, optical disk, and the like, and comprises several instructions to enable a computer device, which may be a personal computer, a server, or a network device, etc., to perform the methods described in various embodiments or some parts of the embodiments.

The above descriptions are only directed to the preferred embodiments of the preferred invention. It should be noted that those skilled in the art can make various improvements and variations without departing from the principle of the present invention. All these improvements and variations fall within the scope of the present invention.

What is claimed is:

1. A charging method for a terminal comprising at least a master device supply, comprising:
detecting a power level of a battery of a second terminal when the second terminal is in connection with the terminal; and
when the power level of the battery of the second terminal is less than a predetermined first charge threshold, controlling the master device supply to be connected with the battery of the second terminal, such that the master device supply charges the battery of the second terminal.

2. The method according to claim 1, wherein the master device supply comprises a master device supply adapter or a master device battery.

3. The method according to claim 2, wherein when the master device supply is the master device supply adapter, and the master device supply adapter is connected with an external power supply, the method further comprises:
when the power level of the battery of the second terminal reaches the predetermined first charge threshold, controlling the master device supply to be connected with the battery of the terminal, such that the master device supply charges the battery of the terminal.

4. The method according to claim 3, further comprising:
when the power level of the battery of the terminal reaches a predetermined second charge threshold, controlling the master device supply to resume the charging of the battery of the second terminal; and
after the battery of the second terminal is fully charged, controlling the master device supply to resume the charging of the battery of the terminal.

5. The method according to claim 1, wherein detecting the power level of the battery of the second terminal comprises:
a microprocessor of the terminal acquiring a power state of the battery of the second terminal via a connector and a system management bus; and
determining whether the power level of the battery of the second terminal is less than the predetermined first charge threshold.

6. The method according to claim 3, wherein when the power level of the battery of the second terminal reaches the predetermined first charge threshold, the method further comprises:
a microprocessor of the master device determining whether the battery of the terminal needs to be charged, and if so, controlling the master device supply to be connected with the battery of the terminal such that the master device supply charges the battery of the terminal.

7. A power supplying method for a terminal, comprising:
detecting a connection state of a battery of the terminal when a second terminal is in connection with the terminal;
when the connection of the battery of the terminal is normal, the terminal controlling the battery of the terminal to supply power to the terminal and the second terminal; and
when the power level of the battery of the terminal is less than a predetermined first discharge threshold, the terminal controlling a battery of the second terminal to supply power to the terminal and the second terminal.

8. The method according to claim 7, further comprising:
when the power level of the battery of the second terminal is less than a predetermined second discharge threshold, initiating a low-power alarm or entering a sleep state.

9. The method according to claim 8, wherein when the power level of the battery of the terminal is less than the predetermined first discharge threshold, the method further comprises:
a microprocessor of the terminal determining whether the connection of the battery of the second terminal is normal, and if so, performing the step where the terminal controlling the battery of the second terminal to supply power to the terminal and the second terminal; or otherwise, initiating the low-power alarm or entering the sleep state.

10. The method according to claim 9, further comprising:
the microprocessor of the terminal acquiring the connection state of the battery of the second terminal via a connector and a system management bus; and
determining whether the battery of the second terminal is normally connected according to the connection state.

11. A terminal comprising at least a master device supply, comprising:
a detecting unit, configured for detecting a power level of a battery of a second terminal when the second terminal is in connection with the terminal; and
a control unit, configured for controlling the master device supply to be connected with the battery of the second terminal when the power level of the battery of the second terminal is less than a predetermined first charge threshold, such that the master device supply charges the battery of the second terminal.

12. The terminal according to claim 11, wherein the control unit is further configured for controlling the master device supply to be connected with the battery of the terminal when the power level of the battery of the second terminal reaches the predetermined first charge threshold, such that the master device supply charges the battery of the terminal.

13. The terminal according to claim 12, wherein the control unit is further configured for controlling the master device supply to resume the charging of the battery of the second terminal when power level of the battery of the terminal reaches a predetermined second charge threshold; and after the battery of the second terminal is fully charged, to control the master device supply to resume the charging of the battery of the terminal.

14. The terminal according to claim 11, wherein the control unit comprises a microprocessor, a battery charging chip, and a supply switching chip, wherein:
the microprocessor is configured for sending control information, which indicates charging the battery of the second terminal, to the battery charging chip and the supply switching chip of the terminal when it is determined that the power level of the battery of the second terminal is less than the predetermined first charge threshold; and to send control information, which indicates charging the battery of the terminal, to the battery charging chip and the supply switching chip of the terminal when it is determined that the power level of the battery of the second terminal reaches the predetermined first charge threshold;
the supply switching chip is configured for switching to the battery of the second terminal to charge the battery of the second terminal when receiving the control information sent from the microprocessor and indicating charging the battery of the second terminal; and to switch to the battery of the terminal to charge the battery of the terminal when receiving the control information sent from the microprocessor and indicating charging the battery of the terminal; and
the battery charging chip is configured for controlling charging voltage and current parameters for charging the battery of the terminal or the second terminal when receiving the control information indicating charging the terminal or the second terminal via the supply switching chip.

15. The terminal according to claim 11, wherein the detecting unit comprises:
an acquiring unit configured for acquiring power state of the battery of the second terminal via a connector and a system management bus;
a determination unit configured for determining whether the power level of the battery of the second terminal is less than the predetermined first charge threshold, and send the determination result to the control unit.

16. A terminal, comprising:
a detecting unit configured for detecting a connection state of a battery of the terminal when a second terminal is in connection with the terminal; and
a control unit configured for controlling the battery of the terminal to supply power to the terminal and the second terminal when the second terminal is in connection with the terminal; and to control the battery of the second terminal to supply power to the terminal and the second terminal when the power level of the battery of the terminal is less than a predetermined first discharge threshold.

17. The terminal according to claim 16, further comprising:
an initiating unit configured for initiating a low-power alarm or initiate a sleep state when the power level of the battery of the second terminal is less than a predetermined second discharge threshold.

18. The terminal according to claim 17, wherein the control unit comprises a microprocessor, a supply switching chip, and a rechargeable battery, wherein:
the microprocessor is configured for sending control information, which indicates supplying power by the battery of the terminal, to the supply switching chip of the terminal when the battery of the terminal is normally connected; and to send control information, which indicates supplying power by the battery of the second terminal, to the supply switching chip of the terminal when it is determined that the power level of the battery of the terminal is less than the predetermined first discharge threshold; and
the supply switching chip is configured for using the battery of the terminal to supply power to the terminal and the second terminal when receiving the control information sent from the microprocessor and indicating supplying power by the battery of the terminal; and to switch to the battery of the second terminal to use the battery of the second terminal to supply power to the terminal and the second terminal when receiving the control information sent from the microprocessor and indicating supplying power by the battery of the second terminal.
